(19) United States
(12) Patent Application Publication
(10) Pub. No.: US 2026/0205500 A1
(43) Pub. Date: Jul. 16, 2026

(54) SYSTEMS AND METHODS FOR LOWER LATENCY SERVER SWITCHING FOR CONTENT DELIVERY

(71) Applicant: Comcast Cable Communications, LLC, Philadelphia, PA (US)

(72) Inventors: Alexander GILADI, Denver, CO (US); Alexander Leo BALK, Edmonds, WA (US)

(21) Appl. No.: 19/020,712

(22) Filed: Jan. 14, 2025

(51) Int. Cl. H04L 65/1069

(52) U.S. Cl. CPC H04L 65/1069

(57) ABSTRACT

Methods and systems for lower latency server switching in adaptive streaming are disclosed. A computing device may receive a manifest file related to a content item. The manifest file may describe a plurality of server devices capable of providing copies of the content item to the computing device. The computing device may process a security handshake with a first server device and begin a session with the first server device to receive a copy of the content item. The computing device may navigate a security handshake with one or more additional server devices of the plurality of server devices while the first session is in progress, reducing the time required for the computing device to switch from the first session to a second session with one of the at least one additional server devices.

### BACKGROUND

Adaptive bit-rate streaming is increasingly popular for streaming media, allowing for variable streaming quality based on conditions present during streaming. Switching between different bit-rates mid-stream may be advantageous because consumers may be granted access to high quality media streams as network conditions allow, while continuing to have access to the media in a lower quality format in the case of network difficulties. Adaptive bit-rate streaming leads to consumers having access to higher quality media on average, while also decreasing the prevalence of full interruptions of a stream due to temporarily constrained network conditions. A client device, for example a mobile phone or a laptop computer, may begin a wireless networking session with a server device, for example a content delivery network (CDN) or content origin that is capable of providing the client device access to the desired media stream. However, due to requirements with configuring a wireless communication session and providing suitable privacy measures between the client device and the server device, undesirable levels of latency may be incurred in establishing wireless communication sessions. Thus, improvements are needed to allow for reducing a time required to establish a wireless communication session between a client device and a server device.

### SUMMARY

Systems, methods, and apparatuses are described herein for lower latency server switching in adaptive streaming. For example, systems, methods, and apparatuses are described herein for providing lower latency HTTP server switches in systems that require low-latency and in systems that are associated with geographically large areas of wireless network coverage. A device may establish a communication session, for example a wireless communication session, with a server to receive desired content items. Establishing the communication session typically involves navigating a security handshake process to determine both sides of the session are approved to participate in the session, and switching from one communication session to another communication session typically involves re-navigating the security handshake process between the device and another server. The present disclosure describes processes for reducing the time to switch from a first session with a first server to a second session with a second server by processing the security handshake between the device and the second server while the device is in a session with the first server.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of the disclosure.

### BRIEF DESCRIPTION OF THE DRAWINGS

The following detailed description is better understood when read in conjunction with the appended drawings, wherein like reference numbers refer to like elements throughout, unless specified otherwise. For the purposes of illustration, examples are shown in the drawings; however, the subject matter is not limited to specific elements and instrumentalities disclosed. In the drawings:

FIG. 1 shows an example method.

FIG. 2 shows an example method.

FIG. 3 shows an example system.

FIG. 4 shows an example method.

FIG. 5 shows an example method.

FIG. 6 shows an example method.

FIG. 7 shows an example computing system.

### DETAILED DESCRIPTION

Adaptive bit-rate streaming offers advantages over prior methods by increasing quality of content output while reducing disruptions to content streams. In prior streaming solutions, media content could be streamed to a client device over a communication session at a constant bit-rate. Due to fluctuations in the communication session, for example disruptions to a bandwidth associated with the communication session, content streamed at a constant bit-rate had to be sent at a lower than optimal bit-rate to account for fluctuations in the strength of the communication session. Adaptive bit-rate streaming allows for switching between streams of a particular content item to attempt to optimize the bit-rate at which the content is streamed to a client device throughout the playtime of the stream. Copies of a content item may be prepared with different bit-rates, and the copies may be stored together or separately. Devices requesting access to the content items may receive an indication of different copies of the requested content item and where the different copies are stored. The requesting devices may establish a communication session with one server that stores a first, desired copy of the content item. However, the system may determine that the device should switch from receiving the first copy of the content item to receiving a second copy of the content item. The second copy may not be stored at the same server device, and the requesting device may establish a second communication session with a second server device to receive the second copy of the content item. Switching from the first session to the second session may be improved upon to reduce a latency caused by the switch.

The communication session may comprise a wireless communication session. However, other types of communication sessions and delivery methods may be employed to send content to a requesting client device. For example, wired communication sessions may be used to send content from a server device to a requesting client device. For simplicity, the description herein refers to both communication sessions and wireless communication sessions, but any other suitable communication session may be used to transmit content to a requesting client device.

The client device may determine to switch from a first session to a second session based on a trigger condition, for example a drop in bandwidth. The client device may determine to switch from the first session to the second session based on receiving an instruction (e.g., an out of band instruction) from a server device instructing the client device to switch to another server device to receive the content item. The present disclosure seeks to reduce the time taken to switch from one communication session to another communication session.

A client device, for example a mobile phone, a laptop computer, a desktop computer, a vehicle, a personal digital assistant (PDA), a smart watch, or any other suitable electronic device may communicate with a server device, for example a content origin, an edge computer, or a CDN, and the client device may request access to content from the server device. For example, the server device may be a content origin, and the content may be generated by, recorded by, produced by, or stored at the content origin. For example, the server device may be an edge computer or a CDN, and the content may be stored or cached at the edge computer or the CDN. For example, the CDN may be in communication with the content origin, and the CDN may cache certain content items. Caching content items at the CDN may reduce a time for a client device to receive a copy of the content item, compared to a client device communicating directly with the content origin to retrieve the content item. For example, the CDN may be located closer to the client device, so sending the content item from the cache of the CDN to the client device may incur less latency than sending the content item from the content origin to the client device. The content origin, the CDN, or both may determine suitable content items to be cached at the CDN. For example, a content item that is requested frequently may be cached at the CDN due to a high likelihood the content item will be requested by a client device. For example, the content origin, the CDN, or both may determine a likelihood that the content item will be requested in the future, and the content item may be cached at the CDN based on a threshold likelihood the content item will be requested a threshold number of times.

The client device may request to begin a communication session with the server device. To initiate the communication session, the client device and the server device may require a negotiation of protocols or other requirements to establish a common operating procedure for establishing and maintaining the communication session. The negotiation may comprise an initial handshake to establish the client device and the server device are able to begin the session. Additionally, or alternatively, the client device and the server device may exchange authentication information to determine that each device is allowed to establish the communication session with the other. The process of negotiating session configuration and authenticating devices may comprise one or more round trips of information between the client device and the server device. For example, the client device may initially send a request to the server device to receive a stream of a content item. The server device may respond to the request with a request for authentication of the client device to determine whether the client device is allowed to access the content item stream. The client device may respond to the server device with authentication information to demonstrate the client device is authorized to access the content item stream. The procedure of the server device sending an authentication request and the client device responding with an answer to the authentication request is one round-trip of information, and the minimum time required to process one round trip of information is described as a round-trip time (RTT). A RTT may be described as an amount of time taken for a request to traverse from one endpoint of a network to another endpoint, and back again to the beginning endpoint. RTT’s may be measured in seconds because the length of the request measured in distance may be multiplied by the speed of light, which is the upper limit of the speed of the request traversing the network.

The client device and the server device may exchange authentication information to determine whether the client device is authorized to begin a communication session and receive a content item stream, but the authentication process is not the only information required to be exchanged between the client device and the server device to establish the communication session. Additionally, the client device and the server device may negotiate a shared protocol, security and privacy information, or the like. Each set of information, if negotiated separately, could add additional RTT’s to the setup of the communication session. In a recent implementation, the Internet Engineering Task Force (IETF) defines a protocol called QUIC, which is a transport layer protocol that leverages user datagram protocol (UDP) to pass multiplexed information among endpoints. One of the main goals of QUIC is to reduce the number of RTTs required in establishing a communication session. However, QUIC is currently described with methods of reducing the number of RTTs required when establishing a single communication session between two endpoints. QUIC aims to reduce latency in networks, in part, by supporting data encryption at the packet level natively to remove the need for additional encryption resources outside of the transport layer. QUIC allows for the exchange of setup keys and supported encryption protocols to be sent alongside an initial handshake when setting up the communication session. Doing so reduces at least one RTT over the TCP system still used by many systems today. However, even though QUIC reduces latency in setting up individual communication sessions, switching between communication sessions may still introduce unacceptable levels of latency into sensitive systems, because switching between communication sessions may require additional negotiation of shared encryption protocols between two devices preparing to enter a new session.

In general, client devices may establish a communication session with a server device and receive a stream of a content item. The establishment of the communication session may follow standard procedures, for example the establishment of the communication session may utilize QUIC to initiate the communication session. However, the communication session may experience an interruption, whether due to outages, bandwidth fluctuations, or other interruptions. Upon determining an interruption, the client device may begin to transfer to a new communication session with a new server device to maintain a suitable stream of the content item. Establishing the new communication session may comprise going through the same encryption protocol negotiation by the client device and the server device involved with the initial communication session. Thus, the client device may have to repeat each step in the communication session establishment process with the new server device to create the new communication session. Even when using QUIC, there may be latency introduced into the content stream due to the RTTs taken to negotiate protocols and configure the transport and security of the media content in the new communication session. Thus, switching from a first communication session to a second communication session may incur latency that, in certain scenarios, may have a negative effect on the media content stream.

For example, in a satellite network a client device may communicate through a satellite orbiting the Earth to a server device somewhere else on the Earth. The sheer distance required for a network message to travel from a client device to a satellite, from the satellite to the server device, and then back along the entire path in reverse can take a substantial amount of time (e.g., one RTT in a satellite system may reach into the hundreds of milliseconds or the seconds). If a client device in an active communication session in a satellite communication network is forced to establish a new communication session infrequently there may not be a noticeably negative effect on a media content stream. However, if the client device has to switch communication sessions frequently, or several times in a short period, the length of each RTT may quickly lead to deterioration of the media content stream. Likewise, some systems require extremely low latency and are intolerant of even moderate interruptions to a media content stream. Even though such a system may have relatively short RTTs, the fact that the system requires very low latency could lead to a deterioration of the media content stream in the event that the client device is required to switch between communication sessions one or more times in a threshold period of time.

Though a client device may only receive information from and negotiation with a single server device to establish a communication session for streaming media content, the disclosure herein presents a method for the client device to begin to negotiate protocols for sessions with a plurality of server devices during an initial communication session setup. The client device may not necessarily enter an active communication session with more than one server device at a time. However, the client device may enter an active communication session with one server device, and the client device may concurrently maintain a database of active session identifiers, also referred to herein as session tickets, associated with a plurality of other known server devices. In the event the client device experiences an interruption to the communication session with the initial server device and determines to switch to another communication session with another server device, the client device may choose to enter a communication session with one of the server devices associated with the active session tickets. Because the active session ticket indicates an already pre-prepared communication session negotiation, the client device and server device may not have to exchange the information again at the time of the switch, saving at least one RTT. The client device may maintain and update the session ticket database on an ongoing basis to keep one or more session tickets active and available for the client device to use to switch to a new communication session with a new server device while saving the associated RTT.

The session tickets stored in the session ticket database may be associated with a timeout timer. For example, the timeout timer may be 5 minutes. Thus, after 5 minutes of no activity, the session ticket may time out and the session ticket may be invalid. The client device may be configured to periodically reset or re-establish the session tickets to keep one or more active session tickets in the session ticket database.

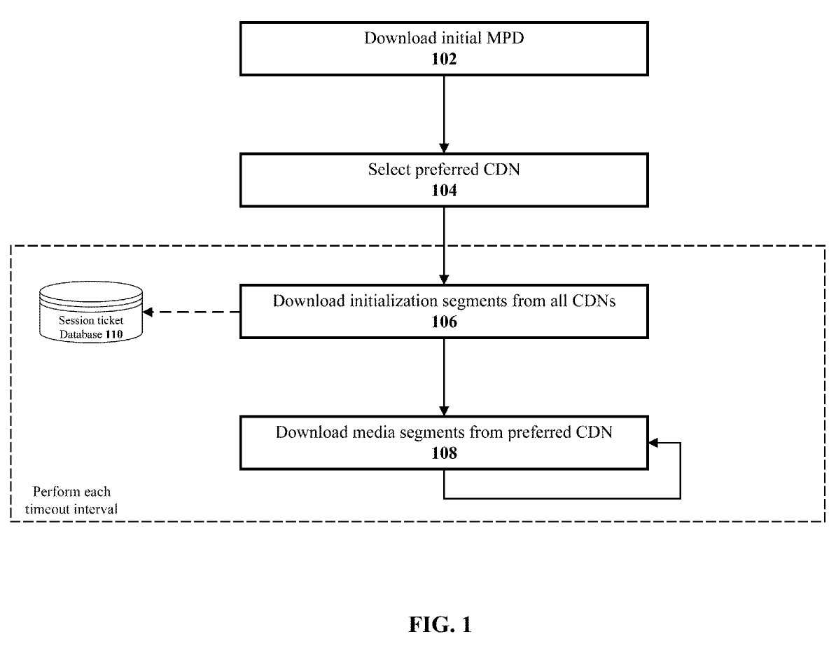

FIG. 1 shows an example method for establishing a communication session and beginning an adaptive stream of a content item as described herein. At step 102, a client device may download an initial media presentation description (MPD). The MPD may be a manifest file. The MPD may comprise metadata of one or more server devices that are available for the client device to retrieve the content item from. For example, the MPD may comprise addresses of each of the one or more server devices. The MPD may comprise metadata associated with copies of the content item requested by the client device. The MPD may indicate any number of server devices, for example the MPD may indicate a plurality of CDNs that are available for streaming the media content to the client device. At step 104, the client device may select a preferred server device, for example a preferred CDN, out of the possible server devices listed in the MPD. The client device may make the determination based on any number of factors, including reliability of the CDN, bandwidth, bit-rate of copies of the content item stored at the CDN, a location of the CDN, an identity of the CDN, or the like. The client device and the selected CDN may establish a communication session.

At step 106, the client device may download an initialization segment from the preferred CDN. The client device may download initialization segments from one or more additional CDNs described in the MPD. For example, the client device may download initialization segments associated with the preferred CDN and establish a communication session between the client device and the preferred CDN. The client device may also download the initialization segments from one or more additional CDNs and proceed with the negotiation of the protocols and security information required to establish a session with each of the one or more additional CDNs. However, the client device may not necessarily enter into additional communication sessions with the additional CDNs concurrently with the communication session entered into with the preferred CDN. The session information related to the one or more additional CDNs may be referred to as session tickets, and the session tickets may be stored at the session ticket database 110.

At step 108, the client device may download media segments from the preferred CDN. The client device and the preferred CDN may maintain an active communication session to facilitate streaming media content from the preferred CDN to the client device. The process may continue for any length of time, and the preferred CDN may send any number of content items to the client device via the communication session. The communication session between the client device and the preferred CDN may be interrupted. The interruption may be minor and the client device and the preferred CDN may maintain the communication session and continue streaming media content. However, the interruption of the communication session may be significant enough for the client device to switch to a different communication session with a different CDN. The client device may determine, based on active session tickets stored in the session ticket database 110, a new preferred CDN to establish a communication session with. The client device may utilize the session ticket to establish a communication session with the new preferred CDN without requiring further negotiation of security and protocol information. The client device may send an initial message to the new preferred CDN to establish the new communication session and send a request for media content in the same initial message. Doing so reduces at least one RTT that would typically be required for the client device to negotiate and establish a new communication session with the new preferred CDN. The client device may begin downloading media segments from the new preferred CDN.

The session tickets may be associated with timeout timers. For example, the timeout timer may be 5 minutes. Thus, after 5 minutes of no activity, the session tickets may time out and the session tickets may be invalid. The client device may be configured to periodically reset or re-establish the session tickets to keep one or more active session tickets in the session ticket database. The client device may determine a timeout interval associated with the one or more session tickets stored at the session ticket database 110. At each timeout interval, or before each timeout interval, the client device may be configured to cause each of the one or more session tickets in the session ticket database 110 to be refreshed.

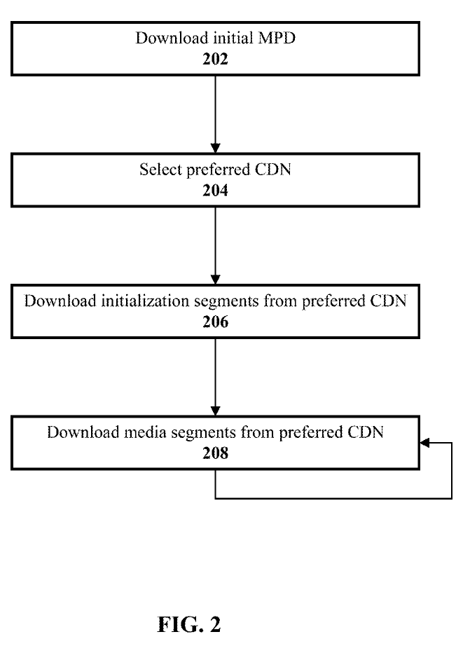

FIG. 2 describes a standard system for establishing a communication session between a client device and a server device, for example a CDN. At step 202, a client device may download an initial media presentation description MPD. The MPD may be a manifest file. The MPD may comprise information associated with copies of a media content item available for streaming and information associated with server devices that the client device is available to receive the particular copies of the media content item from. The MPD may indicate any number of server devices, for example the MPD may indicate a plurality of CDNs that are available for streaming the media content to the client device. At step 204, the client device may select a preferred server device, for example a preferred CDN, out of the possible server devices listed in the MPD. The client device may make the determination based on any number of factors, including reliability of the CDN, bandwidth, bit-rate of copies of the content item stored at the CDN, a location of the CDN, an identity of the CDN, or the like. The client device and the selected CDN may establish a communication session.

At step 206, the client device may download initialization segments, for example, a session ticket, from the preferred CDN described in the MPD. For example, the client device may download initialization segments associated with the preferred CDN and establish a communication session between the client device and the preferred CDN. The client device may not be configured to download the initialization segments from one or more additional CDNs listed in the MPD and the client device may not be configured to proceed with negotiation of protocols and security information required to establish a session with each of the one or more additional CDNs. Therefore, though the client device is able to establish an active session with the preferred CDN, the client device may not be configured to negotiate any part of a session setup with any other CDN indicated in the MPD while the client device maintains the active session with the preferred CDN. Thus, the client device may be configured to only process any steps toward establishing and maintaining a session with a single CDN at a time.

At step 208, the client device may download media segments from the preferred CDN. The client device and the preferred CDN may maintain an active communication session to facilitate streaming media content from the preferred CDN to the client device. The process may continue for any length of time, and the preferred CDN may send any number of content items to the client device via the communication session. The communication session between the client device and the preferred CDN may be interrupted. The interruption may be minor and may not cause a switch to another communication session with another server device, and the client device and the preferred CDN may maintain the communication session and continue streaming media content. However, the interruption of the communication session may be significant enough for the client device to switch to a different communication session with a different CDN. The client device may determine, based on information indicated in the MPD, a new preferred CDN to establish a communication session with. The client device may utilize the MPD and download initialization segments from the new preferred CDN to negotiate protocol and security parameters and establish a new communication session with the new preferred CDN using the same process as the client device used to establish the initial communication session with the initial CDN. The client device may send an initial message to the new preferred CDN to negotiate the protocol and security parameters and establish the new communication session. The client device may separately send a message requesting media content from the new preferred CDN, incurring at least one additional RTT compared to the system described in FIG. 1. The client device may begin downloading media segments from the new preferred CDN.

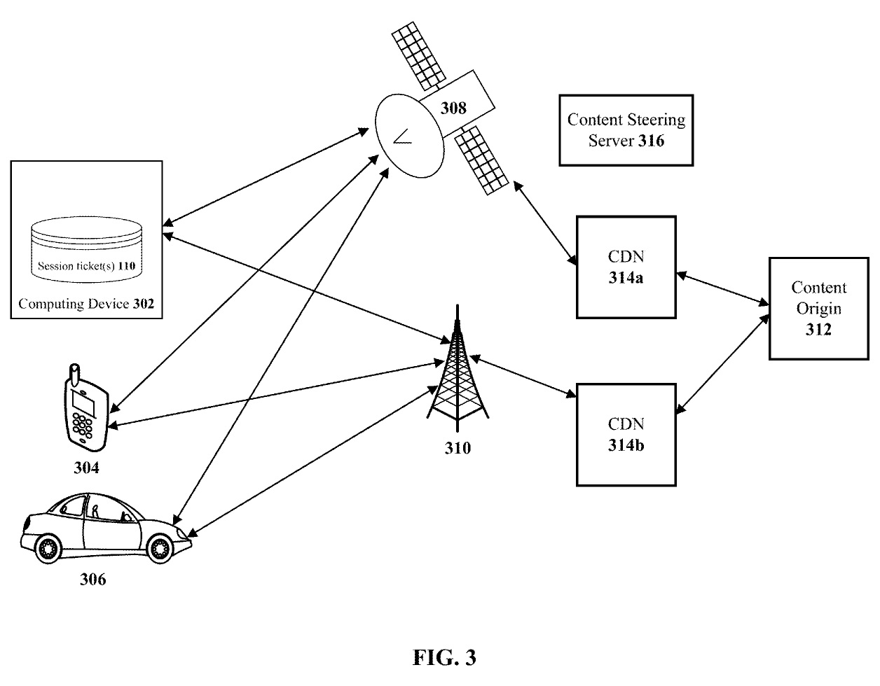

FIG. 3 describes an example system as illustrated in the present disclosure. FIG. 3 particularly describes some of the devices used in connection with establishment of communication sessions with server devices, for example with CDNs, and in sending content items from the server devices to requesting devices via the communication sessions. A content origin 312 may generate, create, produce, store, or otherwise have media content at the content origin 312. Any number of users using any number of user devices may be interested in accessing the media content stored at the content origin 312. For example, a user may use a computing device 302, a user may use a mobile device 304, a user may use a vehicle 306, or a user may use any other suitable device to request access to a stream of the media content stored at the content origin 312. The system also describes one or more other server devices configured to store copies of the content item. For example, CDN 314a and CDN 314b may neither, either, or both store copies of content items available at the content origin 312. The CDNs may be located closer to requesting entities, and the CDNs 314a and 314b may be able to provide content items to requesting devices quicker than the content origin 312. For example, the system may utilize many CDNs at many locations in relation to requesting devices. The CDNs may be located much closer to various computing devices than the content origin 312. Thus, computing devices, for example computing device 302, may be able to retrieve a copy of a content item from a CDN 314a with much less latency than retrieving a copy of the content item from the content origin 312. The satellite 308 and the base station 310 may act as intermediaries between the computing device 302, mobile phone 304, vehicle 306, and the CDNs 314a and 314b and the content origin 312.

In one example, a user associated with computing device 302 may request access to a content item stored at the content origin 312. The content item may not be stored or otherwise cached at either CDN 314a or 314b, so the computing device 302 may establish a communication session with the content origin 312 and retrieve the content item. The computing device 302 may send a request through at least one of the satellite 308 or the base station 310, and the request may be relayed to the content origin 312. The content origin may send a stream of the content item to the computing device 302 via the same path as the computing device 302 used to send the request for the content item. The traversal of the request and receipt of the content item all the way to the content origin 312 may require a relatively large amount of time. On the other hand, the content item may be stored or otherwise cached at either, or both of, CDN 314a or CDN 314b.. Thus, the computing device 302 may request access to the content item via the CDN 314a or CDN 314b, and the CDN 314a or CDN 314b may directly return a stream of segments of the content item to the computing device 302. In this way, caching content items at intermediary devices, for example CDNs, can reduce a total time to receive a stream of segments of a content item.

A client device may experience an interruption to a session in which the client device is receiving a stream of the content item, or a determination may otherwise be made to switch the client device to another session with another server device. For example, the client device may be receiving a stream of the content item from a session with CDN 314a, and a content steering server 316 may determine that the client device should switch from a session with CDN 314a to CDN 314b or to content origin 312. The content steering server 316 may send an indication to the computing device 302 to make the switch to a session with CDN 314b. The computing device 302 may have a database for storing a plurality of active session tickets 110. For example, during the initial handshake process for establishing a first session with CDN 314a (e.g., or within a predetermined time period afterwards), the computing device 302 may also retrieve session tickets from CDN 314b and from content origin 302. The content steering server 316 may determine that the computing device 302 should switch to a new communication session with CDN 314b, and the content steering server 316 may cause the computing device 302 to switch to the new communication session with the CDN 314b. Additionally, or alternatively, the content steering server 316 may determine one or more additional server devices that are able to provide the content item to the computing device 302. The content steering server 316 may inform the computing device 302 of the one or more additional server devices, and the computing device 302 may request session tickets from each of the one or more additional server devices.

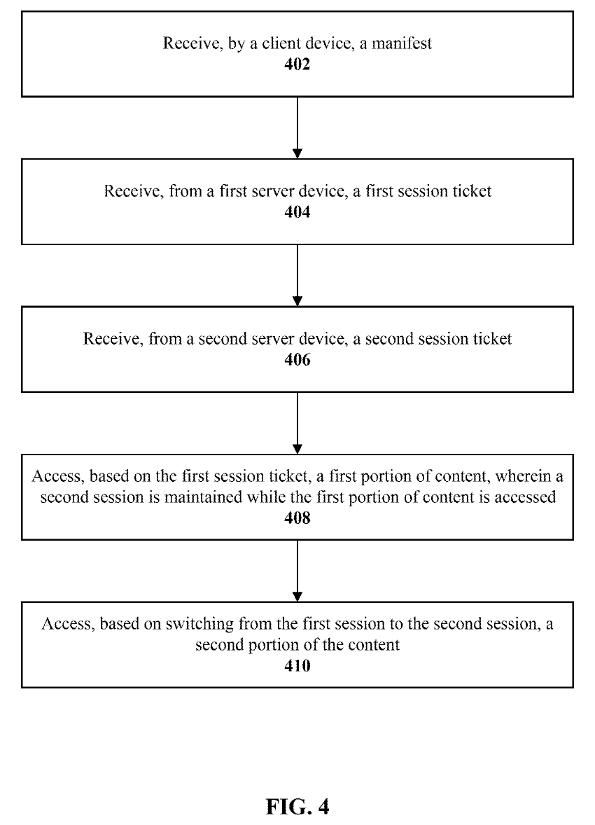

FIG. 4 describes a method for a client device to send a request for a content item and receive a stream of the content item from at least one server device. In step 402, the client device may receive a manifest file. The manifest file may comprise indications of copies of the content item the client device is able to access. The manifest file may comprise indications of a plurality of server devices able to provide the content item to the client device. The plurality of server devices may store a copy of the content item at one of a plurality of bit-rates, or the plurality of server devices may store multiple copies of the content item at a same or different bit-rates. In step 404, the client device may receive, from a first server device, a first session ticket associated with establishing a session between the client device and the first server device. The session ticket may comprise indications of any number of security parameters or configuration protocols to facilitate establishment of the communication session between the client device and the first server device. The session ticket may comprise information for the client device to use to negotiate a shared communication session between the client device and the first server device. The session ticket may also comprise a plurality of device identifiers, and each device identifier may be associated with a different computing device. For example, each one of the plurality of identifiers may be associated with a different server device. For example, each one of the plurality of identifiers may be associated with a different CDN.

At step 406, the client device may receive, from a second server device, a second session ticket associated with establishing a second session between the client device and the second server device. The second session ticket may comprise indications of any number of security parameters or configuration protocols to facilitate establishment of the communication session between the client device and the second server device. The second session ticket may comprise information for the client device to use to negotiate a shared communication session between the client device and the second server device. The second session ticket may also comprise a plurality of device identifiers. Each device identifier may be associated with a different computing device. For example, each one of the plurality of identifiers may be associated with a different server device. For example, each one of the plurality of identifiers may be associated with a different CDN.

The client device may maintain the second session ticket in a database associated with the client device, for example the client device may store the second session ticket. The second session ticket may remain active. The second session ticket may remain active for a period of time, for example five minutes. The second session ticket may be maintained in an active state while the client device is in a first session with the first server device.

At step 408, the client device may access, based on the first session ticket and from the first server device, a first portion of the requested content item. For example, the client device may receive one or more segments of the content item at a particular bit-rate, and the bit-rate may be constant with respect to the segments received from the first server device. The client device may maintain the second session ticket in an active state while the client device is in a first session with the first server device and receiving the first portion of the requested content item from the first server device.

At step 410, the client device may switch from a first session with the first server device to a second session with a second server device. The determination to switch to the second session may be made by the first server device, the second server device, the client device, a content steering device, or the like. The client device may, using the active second session ticket, establish the second session with the second server device. The client device may shut down the first session with the first server device. The client device may access, from the second server device via the second session, a second portion of the content.

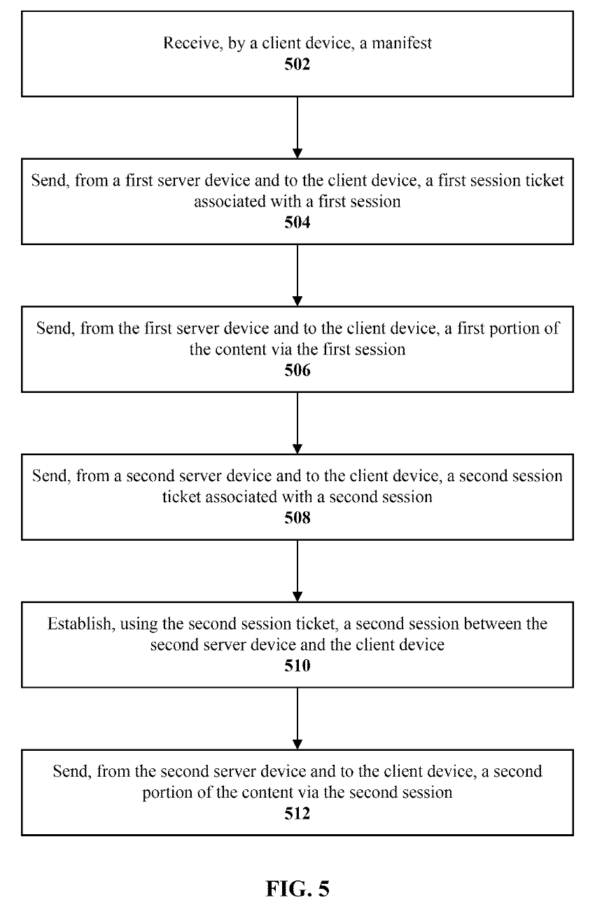

FIG. 5 describes a system for a computing device to receive a request from a client device for a content item and cause a stream of the content item to be sent from at least one server device to the client device. In step 502, the client device may receive a manifest file. The manifest file may comprise indications of copies of the content item the client device is able to access. The manifest file may comprise indications of a plurality of server devices able to provide the content item to the client device. The plurality of server devices may store copies of the content item at one of a plurality of bit-rates, or the server devices may store multiple copies of the content item at a same or different bit-rates. At step 504, the first server device may send, to the client device, a first session ticket associated with establishing a first session between the client device and the first server device. The first session ticket may comprise indications of any number of security parameters or configuration protocols to facilitate establishment of the communication session between the client device and the first server device. The first session ticket may comprise information for the client device to use to negotiate a shared communication session between the client device and the first server device. The first session ticket may also comprise a plurality of device identifiers, and each device identifier may be associated with a different computing device. For example, each one of the plurality of identifiers may be associated with a different server device. For example, each one of the plurality of identifiers may be associated with a different CDN.

At step 506, the first server device may send, based on the first session ticket and to the client device, a first portion of the requested content item. For example, the first server device may send one or more segments of the content item at a particular bit-rate, and the bit-rate may be constant with respect to the segments sent to the client device.

At step 508, the second server device may send, to the client device, a second session ticket associated with establishing a second session between the client device and the second server device. The second session ticket may comprise indications of any number of security parameters or configuration protocols to facilitate establishment of the communication session between the client device and the second server device. The second session ticket may comprise information for the client device to use to negotiate a shared communication session between the client device and the second server device. The second session ticket may also comprise a plurality of device identifiers, and each device identifier may be associated with a different computing device. For example, each one of the plurality of identifiers may be associated with a different server device. For example, each one of the plurality of identifiers may be associated with a different CDN.

The client device may maintain the second session ticket in a database associated with the client device, for example the client device may store the second session ticket. The second session ticket may remain active. The second session ticket may remain active for a period of time, for example five minutes. The second session ticket may be maintained in an active state while the client device is in a first session with the first server device.

At step 510, the client device may establish, using the second session ticket, a second session between the second server device and the client device. The client device may switch from the first session with the first server device to the second session with the second server device. The determination to switch to the second session may be made by the first server device, the second server device, the client device, a content steering server device, or the like. The client device may, using the active second session ticket, establish the second session with the second server device. The client device may shut down the first session with the first server device.

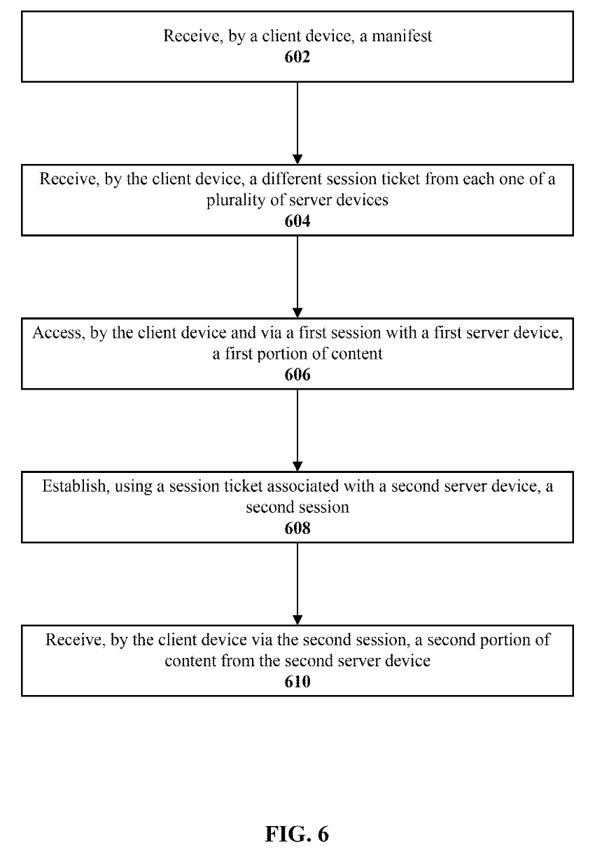

At step 512, the second server device may send a second portion of the content item to the client device via the second communication session. The second portion of the content item may comprise a different bit-rate than the first portion of the content item sent to the client device from the first server device, or the second portion of the content item may comprise a same bit-rate as the first portion of the content item. The second session may have a better bandwidth than the first session. The first session may have experienced a total disruption. A content steering server may determine to cause the client device to switch to the second communication session to load balance a plurality of client devices in communication sessions with a plurality of server devices storing copies of the content item. The client device may establish the second session with the second server device due to conditions related to the first server device, the second server device, both server devices, or neither server device. The client device may establish the second session with the second server device based on a determination made by the client device, the first server device, the second server device, or a content steering server device, or the like. FIG. 6 describes a method for a client device to send a request for a content item to a plurality of server devices and to receive a stream of the content item from at least one server device of the plurality of server devices. The client device may send a request to a plurality of server devices, for example a plurality of edge locations or a plurality of CDNs, for a content item. In step 602, the client device may receive a manifest file. The manifest file may comprise indications of copies of the content item the client device is able to access. The manifest file may comprise indications of a plurality of server devices able to provide the content item to the client device. The server devices may store a copy of the content item at one of a plurality of bit-rates, or the server devices may store multiple copies of the content item at a same or different bit-rates. At step 604, the client device may receive, from each of the plurality of server devices, a different session ticket associated with establishing a session between the client device and the plurality of server devices. The session tickets may comprise indications of any number of security parameters or configuration protocols to facilitate establishment of the communication session between the client device and the server devices. The session tickets may comprise information for the client device to use to negotiate communication sessions between the client device and the server devices. The session tickets may also comprise a plurality of device identifiers, and each device identifier may be associated with a different computing device. For example, each one of the plurality of identifiers may be associated with a different server device of the plurality of server devices. For example, each one of the plurality of identifiers may be associated with a different CDN. The client device may be able to navigate a security parameter, for example a security handshake, to set up a session between the client device and one of the plurality of server devices. For example, the client device may navigate a first security handshake with a first server device and the client device may navigate any number of additional security handshakes with any number of additional server devices of the plurality of server devices. The client device may navigate the first security handshake and one or more additional security handshakes prior to establishing a first session with the first server device. The client device may navigate the first security handshake with the first server device and later navigate one or more additional security handshakes with one or more additional server devices.

At step 606, the client device may establish, by using a first session ticket of the session tickets, a session associated with a first server device of the plurality of server devices. The client device may access, based on the first session ticket and from the first server device, a first portion of the requested content item. For example, the client device may receive one or more segments of the content item at a particular bit-rate, and the bit-rate may be constant with respect to the segments received from the first server device.

At step 608, the client device may establish, using the second session ticket, a second session between the second server device and the client device. The client device may switch from the first session with the first server device to the second session with the second server device based on a change to the first session. The client device may determine an interruption of the first communication session between the client device and the first server device. The interruption may be based on an outage associated with the first server device, a decreased bandwidth below a threshold bandwidth, an instruction from the first server device or another device that the client device should switch to a different communication session with another server device, or the like. The determination to switch to the second session may be made by the first server device, the second server device, the client device, a content steering server device, or the like. The client device may, using the active second session ticket, establish the second session with the second server device. The client device may shut down the first session with the first server device. The client device may be configured to receive some or all of the content from the second server device via the second session. At step 610, the client device may receive, from the second server device and via the second session, a second portion of the content. The second portion of the content item may comprise a different bit-rate than the first portion of the content item sent to the client device from the first server device. The second portion of the content item may comprise a same bit-rate as the first portion of the content item.

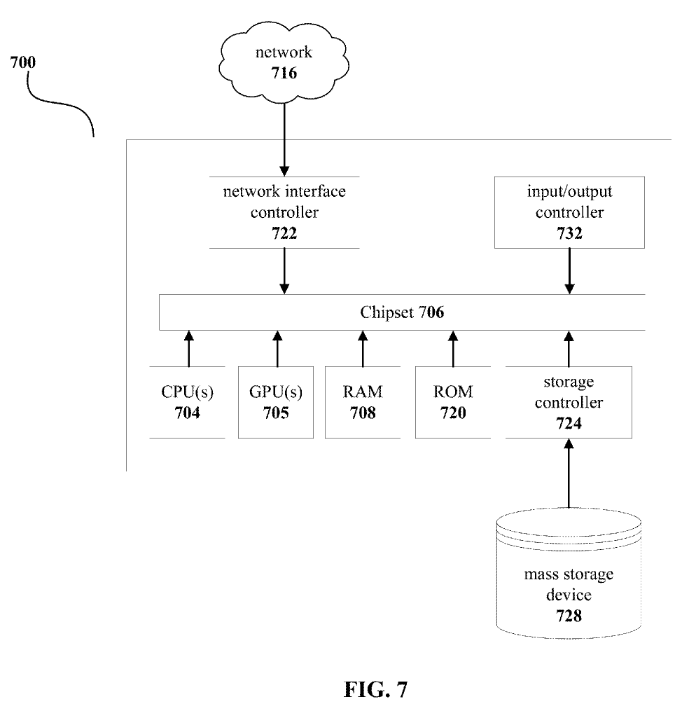

FIG. 7 shows an example computing device 700. The example computing device 700 may be used to implement any of the various devices or entities shown in FIG. 1 or FIG. 3, including, for example, the computing device 302, the user device 304, the vehicle 306, the satellite 308, the base station 310, the CDN 314a or 314b, the content steering server device 316, or the content origin 312. That is, the computing device 700 shown in FIG. 7 may comprise any smartphone, server computer, workstation, access point, router, gateway, tablet computer, laptop computer, notebook computer, desktop computer, personal computer, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIGS. 1 or 3, or any of the methods described in relation to FIGS. 1, 2, or 4-6.

The computing device 700 may comprise a baseboard, or “motherboard,” which is a printed circuit board to which a multitude of components or devices may be connected by way of a system bus or other electrical communication paths. One or more central processing units (CPUs or “processors”) 704 may operate in conjunction with a chipset 706. The CPU(s) 704 may be standard programmable processors that perform arithmetic and logical operations necessary for the operation of the computing device 700.

The CPU(s) 704 may perform the necessary operations by transitioning from one discrete physical state to the next through the manipulation of switching elements that differentiate between and change these states. Switching elements may generally comprise electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, or the like.

The CPU(s) 704 may be augmented with or replaced by other processing units, such as GPU(s) 705. The GPU(s) 705 may comprise processing units specialized for but not necessarily limited to highly parallel computations, such as graphics and other visualization-related processing.

A chipset 706 may provide an interface between the CPU(s) 704 and the remainder of the components and devices on the baseboard. The chipset 706 may provide an interface to a random-access memory (RAM) 708 used as the main memory in the computing device 700. The chipset 706 may provide an interface to a computer-readable storage medium, such as a read-only memory (ROM) 720 or non-volatile RAM (NVRAM) (not shown), for storing basic routines that may help to start up the computing device 700 and to transfer information between the various components and devices. ROM 720 or NVRAM may also store other software components necessary for the operation of the computing device 700 in accordance with the aspects described herein.

The computing device 700 may operate in a networked environment using logical connections to remote computing nodes and computer systems. The chipset 706 may comprise functionality for providing network connectivity through a network interface controller (NIC) 722. A NIC 722 may be capable of connecting the computing device 700 to other computing nodes over the system. It should be appreciated that multiple NICs 722 may be present in the computing device 700, connecting the computing device to other types of networks and remote computer systems. The NIC 722 may be configured to implement a wired local area network technology, such as IEEE 802.3 (“Ethernet”) or the like. The NIC 722 may also comprise any suitable wireless network interface controller capable of wirelessly connecting and communicating with other devices or computing nodes on the system 100. For example, the NIC 722 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, or the like.

The computing device 700 may be connected to a mass storage device 728 that provides non-volatile storage (i.e., memory) for the computer. The mass storage device 728 may store system programs, application programs, other program modules, and data, which have been described in greater detail herein. The mass storage device 728 may be connected to the computing device 700 through a storage controller 724 connected to the chipset 706. The mass storage device 728 may consist of one or more physical storage units. A storage controller 724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 700 may store data on a mass storage device 728 by transforming the physical state of the physical storage units to reflect the information being stored. The specific transformation of a physical state may depend on various factors and on different implementations of this description. Examples of such factors may comprise, but are not limited to, the technology used to implement the physical storage units and whether the mass storage device 728 is characterized as primary or secondary storage or the like.

For example, the computing device 700 may store information to the mass storage device 728 by issuing instructions through a storage controller 724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 may read information from the mass storage device 728 by detecting the physical states or characteristics of one or more particular locations within the physical storage units.

In addition to the mass storage device 728 described herein, the computing device 700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 700.

By way of example and not limitation, computer-readable storage media may comprise volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 728 depicted in FIG. 7, may store an operating system utilized to control the operation of the computing device 700. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 728 may store other system or application programs and data utilized by the computing device 700.

The mass storage device 728 or other computer-readable storage media may also be encoded with computer-executable instructions, which, when loaded into the computing device 700, transforms the computing device from a general-purpose computing system into a special-purpose computer capable of implementing the aspects described herein. These computer-executable instructions transform the computing device 700 by specifying how the CPU(s) 704 transition between states, as described herein. The computing device 700 may have access to computer-readable storage media storing computer-executable instructions, which, when executed by the computing device 700, may perform the methods described in relation to FIGS. 24 and 25.

A computing device, such as the computing device 700 depicted in FIG. 7, may also comprise an input/output controller 732 for receiving and processing input from a number of input devices, such as a keyboard, a mouse, a touchpad, a touch screen, an electronic stylus, or other type of input device. Similarly, an input/output controller 732 may provide output to a display, such as a computer monitor, a flat-panel display, a digital projector, a printer, a plotter, or other type of output device. It will be appreciated that the computing device 700 may not comprise all of the components shown in FIG. 7, may comprise other components that are not explicitly shown in FIG. 7, or may utilize an architecture completely different than that shown in FIG. 7.

As described herein, a computing device may be a physical computing device, such as the computing device 700 of FIG. 7. A computing device may also comprise a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is not intended to be limiting.

As used in the specification and the appended claims, the singular forms “a,” “an,” and “the” comprise plural referents unless the context clearly dictates otherwise. Ranges may be expressed herein as from “about” one particular value, and/or to “about” another particular value. When such a range is expressed, another example may comprise from the one particular value and/or to the other particular value. It will be further understood that the endpoints of each of the ranges are significant both in relation to the other endpoint, and independently of the other endpoint.

“Optional” or “optionally” means that the subsequently described event or circumstance may or may not occur, and that the description comprises instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of.” “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any combination of the described methods.

As will be appreciated by one skilled in the art, the methods and systems may take the form of entirely hardware, entirely software, or a combination of software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

The methods and systems are described above with reference to block diagrams and flowcharts of methods, systems, apparatuses, and computer program products. It will be understood that each block of the block diagrams and flowcharts, and combinations of blocks in the block diagrams and flowcharts, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added or removed. The example systems and components described herein may be configured differently than described. For example, elements may be added to, removed from, or rearranged.

It will also be appreciated that various items are shown as being stored in memory or on storage while being used, and that these items or portions thereof may be transferred between memory and other storage devices for purposes of memory management and data integrity. Alternatively, some or all of the software modules and/or systems may execute in memory on another device and communicate with the shown computing systems via inter-computer communication. Furthermore, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms. Accordingly, the present invention may be practiced with other computer system configurations.

While the methods and systems have been described in connection with specific examples, it is not intended that the scope be limited to the specific examples set forth.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including matters of logic with respect to arrangement of steps or operational flow and the plain meaning derived from grammatical organization or punctuation.

It will be apparent to those skilled in the art that various modifications and variations may be made without departing from the scope or spirit of the present disclosure. Alternatives will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, by a client device, a manifest comprising an indication of a first server device for accessing content and an indication of a second server device for accessing the content;
receiving, from the first server device and based on a first request from the client device, a first session identifier associated with accessing the content via a first session with the first server device;
receiving, from the second server device and based on a second request from the client device, a second session identifier associated with accessing the content via a second session;
accessing, based on the first session and from the first server device, a first portion of the content, wherein the second session identifier, associated with the second session, is maintained while the first portion of the content is accessed via the first session;
accessing, based on switching from the first session to the second session and using the second session identifier, a second portion of the content.

2. The method of claim 1, wherein the client device switches from accessing the content via the first session to accessing the content via the second session based on a change to the first session.

3. The method of claim 2, wherein the change to the first session comprises at least one of a quality of the first session dropping below a threshold quality, a bandwidth of the first session dropping below a threshold bandwidth, or receiving an instruction for the client device to switch to a different session.

4. The method of claim 1, further comprising:
receiving, from a third server device, a third session identifier;
establishing, based on the third session identifier, a third session with the third server device; and
receiving, from the third server device and via the third session, a third portion of the content.

5. The method of claim 1, wherein the first server device and the second server device each comprise at least one of a content delivery network, an edge location, a satellite, a base station, or a content origin.

6. The method of claim 1, wherein the first session identifier comprises one or more of a setup key, a cryptographic protocol supported by the first server device and the second server device, or a digital certificate.

7. The method of claim 1, wherein the first server device is associated with a first geographic area and the second server device is associated with a second geographic area, and wherein the client device switches from accessing the content via the first session to accessing the content via the second session based at least in part on movement of the client device from the first geographic area to the second geographic area.

8. The method of claim 1, wherein the second session identifier associated with the second session comprises a threshold timeout time, and further comprising sending a request, by the client device and to the second server device, to refresh the second session identifier associated with the second session.

9. A system comprising:
a client device configured to receive a manifest associated with accessing content; and
a plurality of server devices comprising a first server device and a second server device, wherein the first server device is configured to:
send, to the client device and based on a first request from the client device, a first session identifier, the first session identifier associated with providing the client device access to the content via a first session between the client device and the first server device; and
send, to the client device, a first portion of the content; and
the second server device is configured to:
send, based on a second request from the client device, a second session identifier, the second session identifier associated with providing the client device access to the content via a second session between the client device and the second server device; and
send, to the client device, a second portion of the content via the second session, wherein the client device is configured to establish the second session based on a change to the first session.

10. The method of claim 9, wherein the change comprises at least one of a quality of the first session dropping below a threshold quality, a bandwidth of the first session dropping below a threshold bandwidth, or sending an instruction for the client device to switch to a different session.

11. The method of claim 9, wherein the first server device and the second server device each comprise at least one of a content delivery network, an edge location, a satellite, a base station, or a content origin.

12. The method of claim 9, wherein the first session identifier comprises one or more of a setup key, a cryptographic protocol supported by the plurality of server devices, or a digital certificate.

13. The method of claim 9, wherein the first server device is associated with a first geographic area and the second server device is associated with a second geographic area, and wherein the change to the first session is based at least in part on movement of the client device from the first geographic area to the second geographic area.

14. The method of claim 9, wherein the second session comprises a threshold timeout time, further comprising receiving a request, at the second server device, to refresh the second session identifier associated with the second session.

15. A method comprising:
receiving, by a client device and based on a request for content, a manifest comprising indications of a plurality of server devices;
receiving, based on one or more requests by the client device and from each one of the plurality of server devices, a different session identifier, wherein each session identifier is associated with a session between the client device and a different server device of the plurality of server devices;
accessing, by the client device and based on a first session associated with a first server device of the plurality of server devices, a first portion of the content;
establishing, based on a change to the first session and using a session identifier associated with a second server device of the plurality of server devices, a second session between the client device and the second server device of the plurality of server devices; and
receiving, via the second session, a second portion of the content from the second server device.

16. The method of claim 15, wherein the change to the first session comprises at least one of a quality of the first session dropping below a threshold quality, a bandwidth of the first session dropping below a threshold bandwidth, or receiving an instruction for the client device to switch to a different session.

17. The method of claim 15, wherein the session identifier comprises one or more of a setup key, a cryptographic protocol supported by at least one of the first server device or the second server device, or a digital certificate.

18. The method of claim 15, wherein the plurality of server devices comprises one or more of a content delivery network, an edge location, a satellite, a base station, or a content origin.

19. The method of claim 15, wherein the first server device is associated with a first geographic area and the second server device is associated with a second geographic area, and wherein the change to the first session is based at least in part on movement of the client device from the first geographic area to the second geographic area.

20. The method of claim 15, wherein the second session comprises a threshold timeout time, further comprising sending a request, by the client device and to the second server device, to refresh the session identifier associated with the second session.
